(19) United States
(12) Patent Application Publication
(10) Pub. No.: US 2024/0269778 A1
(43) Pub. Date: Aug. 15, 2024

(54) LASER WELDING DEVICE

(71) Applicant: TOYOTA JIDOSHA KABUSHIKI KAISHA, Toyota-shi (JP)

(72) Inventors: Shotaro KUROKAWA, Nisshin-shi (JP); Kohei TAKAHASHI, Nisshin-shi (JP); Tomohiko SEKIGUCHI, Nagakute-shi (JP)

(73) Assignee: TOYOTA JIDOSHA KABUSHIKI KAISHA, Toyota-shi (JP)

(21) Appl. No.: 18/398,316

(22) Filed: Dec. 28, 2023

(30) Foreign Application Priority Data
Feb. 9, 2023 (JP) 2023-018518

(51) Int. Cl. B23K 26/70; B23K 26/08; B23K 26/21

(52) U.S. Cl. CPC B23K 26/702; B23K 26/083; B23K 26/21

(57) ABSTRACT

A laser welding device that welds an object to be welded including two or more members includes: a welding laser irradiation unit that faces the object, the welding laser irradiation unit welding the object by irradiating a target portion of the object with laser light; and a heating device disposed on an opposite side to the welding laser irradiation unit seen from the object, the heating device preheating the target portion by heating the target portion from the opposite side.

### CROSS REFERENCE TO RELATED APPLICATIONS

This application is based upon and claims benefit of priority from Japanese Patent Application No. 2023-18518, filed on Feb. 9, 2023, the entire contents of which are incorporated herein by reference.

### BACKGROUND

### Field

The present disclosure relates to a laser welding device.

### Related Art

There is known a technique of laser welding that a preheating device preheats a target portion of an object to be welded to prevent cracking of the object. For example, JP 2010-184248 A discloses a laser welding device that includes a laser irradiation unit for welding, and a preheating device that radiates a light beam. The laser irradiation unit and the preheating device are disposed above an object to be welded in this laser welding device.

In a case where both of the laser irradiation unit and the preheating device are disposed above an object to be welded as in JP 2010-184248 A, for example, the size and an installation angle of the preheating device, and a distance from the object need to be set such that the preheating device does not contact the laser irradiation unit and the preheating device does not block a laser beam. Hence, a configuration of the preheating device is restricted by the laser irradiation unit in JP 2010-184248 A.

### SUMMARY

The present disclosure can be achieved as following aspects.

One aspect of the present disclosure provides a laser welding device that welds an object including two or more members. This laser welding device includes a welding laser irradiation unit that faces the object, the welding laser irradiation unit welding the object by irradiating a target portion of the object with laser light; and a heating device disposed on an opposite side to the welding laser irradiation unit seen from the object, the heating device preheating the target portion by heating the target portion from the opposite side.

### BRIEF DESCRIPTION OF THE DRAWINGS

FIG. 1 is a view illustrating a schematic configuration of a laser welding device according to a first embodiment;

FIG. 2 is a view for describing a target portion according to the first embodiment;

FIG. 3 is a view illustrating a schematic configuration of a laser welding device according to a second embodiment;

FIG. 4 is a view for describing a position of a cover member;

FIG. 5 is a view for describing a target portion according to a third embodiment;

FIG. 6 is a view for describing a object according to a fourth embodiment;

FIG. 7 is a view for describing a target portion according to the fourth embodiment;

FIG. 8 is a first view for describing a target portion according to a fifth embodiment; and

FIG. 9 is a second view for describing a target portion according to the fifth embodiment.

### DETAILED DESCRIPTION

### A. First Embodiment

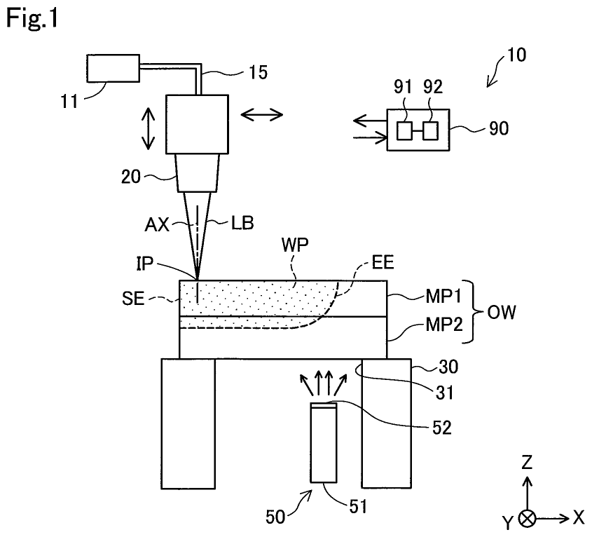

FIG. 1 is a view illustrating a schematic configuration of a laser welding device 10. FIG. 1 illustrates arrows that are orthogonal to each other and go along X, Y, and Z directions. The X, Y, and Z directions are directions that go along an X axis, a Y axis, and a Z axis that are three spatial axes orthogonal to each other, and each include both of one direction that goes along the X axis, the Y axis, or the Z axis, and an opposite direction to the one direction. The X axis and the Y axis are axes that go along a horizontal plane, and the Z axis is an axis that goes along a vertical line. Hereinafter, a +Z direction will be referred to as “upper”, and a −Z direction will be referred to as “lower”.

The laser welding device 10 welds an object OW by irradiating the object OW with laser light LB. The laser welding device 10 includes a laser oscillator 11, a light path 15, a welding laser irradiation unit 20, a stage 30, a heating device 50, and a control unit 90.

The control unit 90 is configured as a computer that includes a CPU 91, a storage unit 92, and an input/output interface. The CPU 91 executes programs stored in the storage unit 92 to cause the control unit 90 to implement various functions including a function of preheating the object OW and a function of welding the object OW. Note that, in other embodiments, the control unit 90 may be configured as, for example, a Programmable Logic Controller (PLC). Furthermore, the functions of the control unit 90 may be implemented by a circuit.

The stage 30 supports the object OW. The object OW includes two or more members. The object OW may constitute, for example, an entire certain member or product, or may be formed as part of a certain member or product. In the present embodiment, the object OW has a plate shape. Furthermore, the object OW includes a first plate member MP1 and a second plate member MP2 as members that constitute the object OW. The first plate member MP1 and the second plate member MP2 are each an aluminum plate of a rectangular plate shape. The first plate member MP1 and the second plate member MP2 are mutually laminated in a plate thickness direction of the object OW. The plate thickness direction in the present embodiment is the Z direction. The second plate member MP2 is placed just above the stage 30. The first plate member MP1 is placed just above the second plate member MP2. A gap between the lower surface of the first plate member MP1 and the upper surface of the second plate member MP2 is preferably small to such a degree that a welding defect caused by this gap can be prevented. For example, to improve adhesion of the first plate member MP1 and the second plate member MP2, a jig (not illustrated) that presses the first plate member MP1 against the second plate member MP2 may be installed on the stage 30 as appropriate.

The meaning of that “the first plate member MP1 and the second plate member MP2 are laminated” includes not only that the first plate member MP1 and the second plate member MP2 are laminated in the plate thickness direction completely overlapping each other, but also that the first plate member MP1 and the second plate member MP2 are laminated in the plate thickness direction such that part of the first plate member MP1 and part of the second plate member MP2 overlap. In a case where the first plate member MP1 and the second plate member MP2 are laminated as in the present embodiment, overlapping portions of both of the first plate member MP1 and the second plate member MP2 are welded.

The laser oscillator 11 oscillates the laser light LB. Types of the laser light LB to be oscillated may be an arbitrary type of, for example, a CO₂ laser, a YAG laser, a fiber laser, a disk laser, an excimer laser, or the like. The laser light LB oscillated by the laser oscillator 11 transmits to the welding laser irradiation unit 20 via the light path 15. The light path 15 is, for example, an optical fiber cable or a mirror for transmitting the laser light LB.

The welding laser irradiation unit 20 condenses the laser light LB transmitted from the laser oscillator 11, and radiates the laser light LB toward the object OW. The welding laser irradiation unit 20 is disposed facing the object OW. The welding laser irradiation unit 20 welds the object OW by irradiating a target portion WP of the object OW with the laser light LB. In the present embodiment, the welding laser irradiation unit 20 is disposed above the object OW so as to face the upper surface of the object OW, and radiates the laser light LB from above the object OW to the plate surface (upper surface) of the object OW. In the present embodiment, an irradiation direction of the laser light LB toward the object OW is the-Z direction. That is, an optical axis AX of the laser light LB radiated from the welding laser irradiation unit 20 goes along the Z direction, and is orthogonal to a planar direction of the object OW. In the other embodiments, the optical axis AX may not be orthogonal to the planar direction of the object OW, that is, may incline in the Z direction.

The welding laser irradiation unit 20 according to the present embodiment is configured as a head that includes a galvano scanner. The welding laser irradiation unit 20 is configured to be able to control a focal position and an irradiation position of the laser light LB radiated on the object OW by changing the angle of a galvano mirror mounted on the galvano scanner under control of the control unit 90. In the present embodiment, the focal position is a position in the Z direction, and the irradiation position is a position in the X direction and the Y direction. Furthermore, the welding laser irradiation unit 20 is configured to be movable with respect to the stage 30. More specifically, the welding laser irradiation unit 20 is fixed to a robot arm (not illustrated), and is moved by an operation of the robot arm under control of the control unit 90. A robot of this robot arm is configured as, for example, a three-axis robot or a six-axis robot. In a case where the robot is configured as the six-axis robot, it is also possible to control the angle of the welding laser irradiation unit 20 with respect to the stage 30. In the other embodiments, the welding laser irradiation unit 20 may be moved by, for example, a horizontal moving mechanism or a lifting mechanism that is configured as an electric actuator.

In FIG. 1, a hatching of a dot pattern is applied to the target portion WP of the object OW. The target portion WP is a portion to be welded in the object OW. More specifically, the target portion WP is a portion that is heated to a melting point or more when irradiated with the laser light LB at a time of welding, and is a portion at which a welding mark is formed by welding. More specifically, the target portion WP includes a portion that is directly irradiated with the laser light LB, and a portion that is melted by heat due to the laser light LB around the irradiated portion. Respective members that constitute the object OW are bonded to each other when the target portion WP is welded. In the present embodiment, the target portion WP does not penetrate the object OW in the irradiation direction of the laser light LB. Thus, a welding method that does not penetrate the object OW is also referred to as non-penetration welding. Note that the welding method that penetrates the object OW is also referred to as penetration welding.

If welding conditions and the object OW are defined in advance, the shape of the target portion WP can be predicted before welding of the object OW actually starts. The shape of the target portion WP may be predicted based on, for example, a result obtained by welding the same object as that of the object OW under the same conditions in advance, or may be predicted based on a simulation result of welding of the object OW.

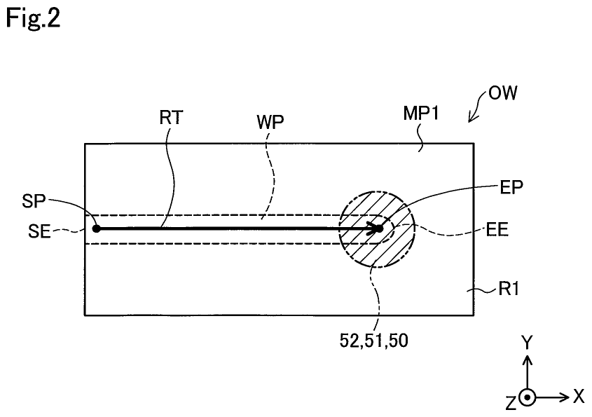

FIG. 2 is a view for describing the target portion WP according to the present embodiment. In the present embodiment, the welding laser irradiation unit 20 is configured to weld the object OW while moving an irradiation position IP of the laser light LB on the object OW. This movement of the irradiation position IP is performed by, for example, changing the angle of the galvano mirror, or moving or changing the angle of the welding laser irradiation unit 20 by the robot arm.

In a case where the object OW is welded while the irradiation position IP is moved, the target portion WP includes a start edge part SE and an end edge part EE. The start edge part SE is a rear edge part of the target portion WP in a movement direction of the irradiation position IP, and is an edge part corresponding to a start point SP of a movement route RT of the irradiation position IP. The start edge part SE is welded at the start point SP of the movement route RT, that is, at the beginning of welding of the target portion WP. The end edge part EE is a front edge part of the target portion WP in the movement direction of the irradiation position IP, and is an edge part corresponding to an end point EP of the movement route RT. The end edge part EE is welded at the end point EP of the movement route RT, that is, at an end of welding of the target portion WP.

In the present embodiment, the control unit 90 moves the welding laser irradiation unit 20 such that the irradiation position IP linearly moves in the +X direction from the start point SP to the end point EP at the time of welding. Hence, as illustrated in FIG. 2, the movement route RT and the target portion WP in the present embodiment linearly extend along the X direction when seen in the Z direction. Furthermore, the end edge part EE is located at a position in the +X direction of the start edge part SE. More specifically, the target portion WP in the present embodiment extends from an edge in the −X direction of the object OW to a position before the edge in the +X direction. Hence, the start edge part SE is located at the edge in the −X direction of the object OW, and the end edge part EE is located between the start edge part SE in the X direction and the edge in the +X direction of the object OW.

As illustrated in FIG. 1, the heating device 50 is disposed on the opposite side to the welding laser irradiation unit 20 seen from the object OW. In the present embodiment, the heating device 50 is disposed below the object OW. The heating device 50 heats the object OW from the opposite side to the welding laser irradiation unit 20, that is, from below. The heating device 50 may be configured such that the heating device 50 can be moved with respect to the stage 30 by, for example, the electric actuator or the robot under control of the control unit 90.

The heating device 50 in the present embodiment is configured as a lamp 51 that heats the target portion WP by irradiating the object OW with infrared light. In the present embodiment, the lamp 51 is configured as a halogen lamp. An irradiation unit 52 of the lamp 51 is formed with fused quartz. The heating device 50 includes the irradiation unit 52 disposed facing upward on an opening part 31 formed in the stage 30. The opening part 31 is opened facing toward an upper side of the stage 30. Hence, the irradiation unit 52 faces a portion that is part of the lower surface of the object OW placed on the stage 30, and that covers the opening part 31.

The description returns to FIG. 2. In the present embodiment, the heating device 50 is disposed overlapping at least part of the end edge part EE when seen from along the Z direction. More specifically, the heating device 50 is disposed such that the center part in the X direction and the Y direction of the irradiation unit 52 of the lamp 51 is located just below the end edge part EE when seen from along the Z direction. In FIG. 2, a hatching that goes in an upper right direction is applied to an area in which the heating device 50 is disposed when seen from the Z direction. The heating device 50 according to the present embodiment heats the end edge part EE in a state where the heating device 50 overlaps at least part of the end edge part EE as described above. Note that, in the present embodiment, the dimensions in the X direction and the Y direction of the object OW are larger than the dimensions in the X direction and the Y direction of the heating device 50. Hence, as illustrated in FIG. 2, the object OW includes an area R1 that does not overlap the heating device 50 that is heating the end edge part EE when seen from along the Z direction. This area R1 is an area that does not overlap the end edge part EE when seen from along the Z direction.

The control unit 90 preheats the object OW by controlling the heating device 50. Preheating the object OW means heating a certain portion of the object OW by the heating device 50 before irradiating this certain portion with the laser light LB. At the time of preheating, the target portion WP is heated to a lower temperature than the melting point of the object OW. The heating temperature of preheating is preferably such a high temperature that occurrence of hot cracking of the target portion WP can be prevented at the time of welding. Note that the heating temperature of preheating may be set taking a preheating completion timing and an irradiation timing of the laser light LB into account. In a case where, for example, a time taken until a certain portion is irradiated with the laser light LB after preheating of this certain portion is completed is short, welding is more likely to be started in a state where a high temperature of the preheated portion is kept compared to a case where this time is longer. Hence, a lower heating temperature may be set in this case. This setting reduces the time and consumption energy required to raise the temperature of the object OW. Furthermore, the control unit 90 may preheat a certain portion, and then irradiate this certain portion with the laser light LB in a state where heating of this certain portion is stopped, or may irradiate this certain portion with the laser light LB while continuing heating this certain portion.

According to the laser welding device 10 according to the above-described present embodiment, the heating device 50 is disposed on the opposite side to the welding laser irradiation unit 20 seen from the object OW, and preheats the target portion WP by heating the target portion WP from the opposite side to the welding laser irradiation unit 20. According to this aspect, it is possible to prevent the configuration of the heating device 50 from being restricted by the welding laser irradiation unit 20 compared to a case where the heating device 50 is disposed on the same side as that of the welding laser irradiation unit 20.

Furthermore, in the present embodiment, the heating device 50 preheats the end edge part EE by heating the end edge part EE. It is generally known that hot cracking is more likely to occur at the end edge part EE compared to other portions of the target portion WP. By preheating this end edge part EE, it is possible to effectively prevent cracking of the object OW.

Furthermore, in the present embodiment, the heating device 50 is disposed overlapping at least part of the end edge part EE of the target portion WP when seen from the plate thickness direction. According to this aspect, the heating device 50 can heat the end edge part EE in a state where the heating device 50 is disposed closer to the end edge part EE compared to, for example, an aspect where the heating device 50 does not overlap the end edge part EE when seen from the plate thickness direction. Consequently, the heating device 50 can efficiently heat the end edge part EE, so that it is possible to more effectively prevent cracking of the object OW.

Furthermore, in the present embodiment, the object OW includes the area R1 that does not overlap the heating device 50 that preheats the end edge part EE when seen from along the Z direction. Consequently, it is possible to prevent heat of the heating device 50 from influencing the area R1.

### B. Second Embodiment

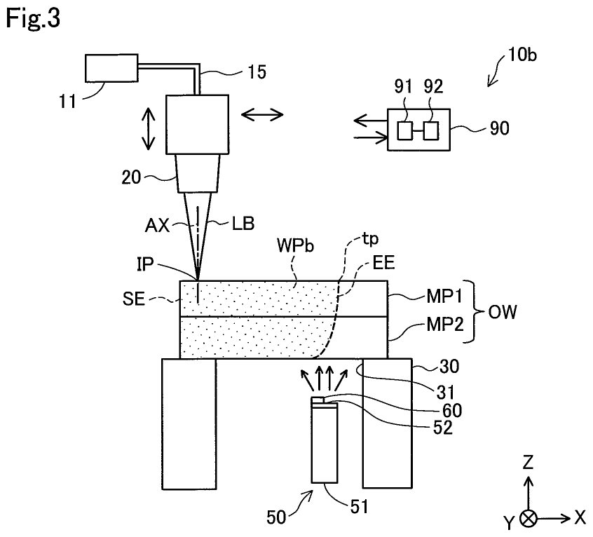

FIG. 3 is a view illustrating a schematic configuration of a laser welding device 10b according to the second embodiment. According to the second embodiment, the laser welding device 10b includes a cover member 60 unlike the first embodiment. Parts that are not described in particular in the configuration of the laser welding device 10b according to the second embodiment are the same as those of the first embodiment.

Similar to FIG. 1, in FIG. 3, a hatching of a dot pattern is applied to a target portion WPb. In the present embodiment, the laser welding device 10b executes penetration welding. That is, the target portion WPb according to the present embodiment penetrates the object OW in the irradiation direction of the laser light LB. Hence, the laser light LB may be radiated on the stage 30 and the opening part 31 when penetrating the object OW.

As illustrated in FIG. 3, the above-described cover member 60 is disposed between the object OW and the irradiation unit 52 of the lamp 51.

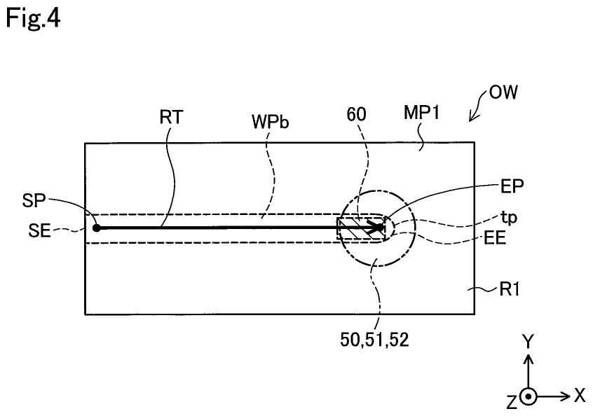

FIG. 4 is a view for describing the position of the cover member 60. In FIG. 4, a hatching that goes in a lower right direction is applied to the position at which the cover member 60 is provided. The cover member 60 covers part of the irradiation unit 52. More specifically, as illustrated in FIG. 4, the cover member 60 overlaps part of the irradiation unit 52 when seen from the Z direction along the optical axis AX. The cover member 60 according to the present embodiment covers part of the irradiation unit 52 from above such that the laser light LB having reached the interior of the opening part 31 is not directly radiated on the irradiation unit 52. More specifically, the cover member 60 is disposed at a portion of the irradiation unit 52 that overlaps the movement route RT when seen from along the optical axis AX. The large dimensions in the X direction and the Y direction of the cover member 60 are set to such a degree that the laser light LB is not directly radiated on the irradiation unit 52 based on the beam diameter of the laser light LB and a distance between the cover member 60 and the welding laser irradiation unit 20.

Furthermore, in the present embodiment, the cover member 60 is disposed without overlapping the entire end edge part EE when seen from along the Z direction. For example, the cover member 60 does not overlap a distal end tp of the end edge part EE when seen from the Z direction as illustrated in FIG. 4.

The cover member 60 has higher heat resistance than those of the object OW and the irradiation unit 52. Note that, as for determination on heat resistance, it may be determined that heat resistance of a material that causes glass transition is higher as a glass transition point of this material is higher. Furthermore, as for a material that does not cause glass transition, it may be determined that heat resistance of this material is higher as the melting point of this material is higher. In a case where the object OW is made of aluminum and the irradiation unit 52 is made of fused quartz as in the present embodiment, the cover member 60 may be formed using, for example, various metals such as steel or stainless steel, or various ceramics such as alumina or silicon nitride. Furthermore, by, for example, increasing the absorptance of the laser light LB of the cover member 60, it is possible to reduce the intensity of the laser light LB radiated on the lamp 51 through the cover member 60, and prevent a thermal influence on the lamp 51. In this case, the cover member 60 may be formed using a material having high absorptance to such a degree that deformation of the lamp 51 due to heat deriving from the laser light LB can be prevented according to the material of the lamp 51 or the wavelength of the laser light LB.

The laser welding device 10b according to the above-described second embodiment includes the cover member 60 that is disposed between the object OW and the irradiation unit 52 of the lamp 51, and overlaps part of the irradiation unit 52 when seen from along the irradiation direction of the laser light LB, and the cover member 60 has the higher heat resistance than those of the object OW and the irradiation unit 52. Consequently, the cover member 60 can protect the irradiation unit 52 from the laser light LB. Furthermore, it is possible to effectively heat the target portion WP by infrared light radiated from the lamp 51 compared to, for example, an aspect where the cover member 60 overlaps the entire irradiation unit 52 when seen from along the irradiation direction of the laser light LB.

Note that, as described in the first embodiment, the laser welding device 10 may not be provided with the cover member 60. In a case where the heating device 50 may be irradiated with the laser light LB during welding in the aspect where the cover member 60 is not provided, the heating device 50 is preferably configured to prevent, for example, deformation of the heating device 50 due to heat deriving from the laser light LB. In this case, for example, the irradiation unit 52 may be formed using a member having higher heat resistance than that of the object OW. Furthermore, for example, the heating device 50 may be disposed much below the object OW to further reduce a thermal influence of the laser light LB on the heating device 50.

### C. Third Embodiment

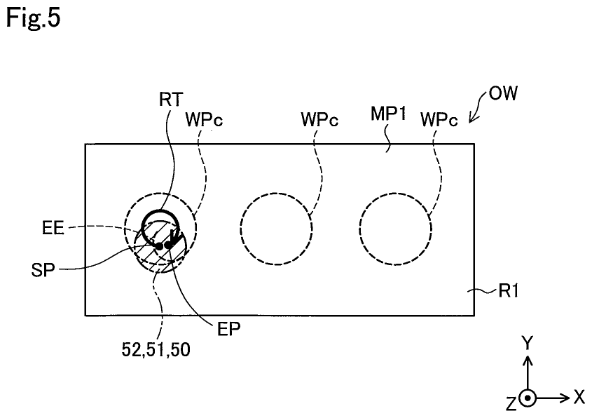

FIG. 5 is a view for describing target portions WPc according to the third embodiment. Unlike the first embodiment, the target portion WPc has a circular shape instead of a linear shape when seen from along the Z direction. Parts that are not described in particular in the configuration of the laser welding device 10 according to the third embodiment are the same as those of the first embodiment.

In the present embodiment, the control unit 90 moves the welding laser irradiation unit 20 such that the irradiation position IP moves drawing a circumferential shape at the time of welding. That is, the movement route RT in the present embodiment has the circumferential shape. In the present embodiment, when the irradiation position IP is moved drawing the circumferential shape in this way at the time of welding, a welding mark is formed along the circumferential direction of the target portion WPc when seen from along the Z direction. Furthermore, after welding is completed, a circular welding mark is left on the object OW when seen from along the Z direction. Note that the movement route RT may be, for example, a route through which the irradiation position IP is moved drawing the circumferential shape over a longer distance than one circumference. Furthermore, the welding method according to the present embodiment may be penetration welding or may be non-penetration welding.

Similar to FIG. 2, in FIG. 5, a hatching that goes in the upper right direction is applied to an area in which the heating device 50 is disposed when seen from the Z direction. Even in a case where the object OW is welded while the irradiation position IP is moved drawing the circumferential shape as in the present embodiment, the heating device 50 heats the end edge part EE of the target portion WPc similar to the first embodiment, so that it is possible to effectively prevent cracking at the end edge part EE. Substantially similar to FIG. 2, FIG. 5 illustrates that the heating device 50 is disposed overlapping the end edge part EE when seen from along the Z direction. Note that the start edge part SE is omitted in FIG. 5 for convenience of illustration.

Furthermore, in a case where the object OW includes the plurality of target portions WPc as illustrated in FIG. 5, for example, a plurality of the heating devices 50 may be disposed in association with the respective target portions WPc. Furthermore, for example, an electric actuator that moves the heating device 50 in the X direction or the Y direction may be provided, and this electric actuator may be controlled by the control unit 90 to move the heating device 50 to a position meeting the end edge part EE of the preheating target portion WPc. FIG. 5 illustrates the three target portions WPc. However, the number of the target portions WPc may be two or may be four or more. Furthermore, the number of the target portions WPc may be one similar to the first embodiment.

The laser welding device 10 according to the above-described third embodiment can prevent the configuration of the heating device 50 from being restricted due to the welding laser irradiation unit 20.

Note that the laser welding device 10 according to the third embodiment may be provided with, for example, the cover member 60 similar to the second embodiment.

### D. Fourth Embodiment

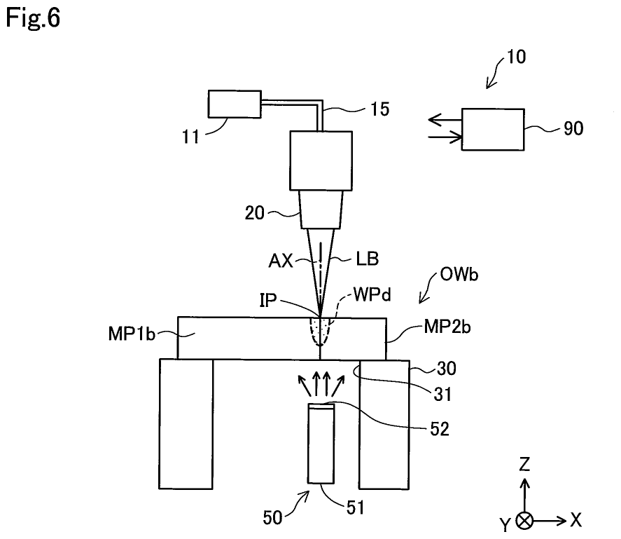

FIG. 6 is a view illustrating an object OWb according to the fourth embodiment. Unlike the first embodiment, a first plate member MP1b according to the present embodiment is aligned with a second plate member MP2b in a planar direction of the object OWb. Note that, similar to FIG. 1, in FIG. 6, a hatching of a dot pattern is applied to the target portion WPd. Parts that are not described in particular in the configuration of the laser welding device 10 according to the fourth embodiment are the same as those of the first embodiment.

As illustrated in FIG. 6, the first plate member MP1b is disposed in the −X direction of the second plate member MP2b. A gap between the side surface in the +X direction of the first plate member MP1b and the side surface in the −X direction of the second plate member MP2b is preferably small to such a degree that a welding defect caused by this gap can be prevented. Substantially similar to the jig described in the first embodiment, in the present embodiment, too, a jig that presses the first plate member MP1b against the second plate member MP2b may be disposed.

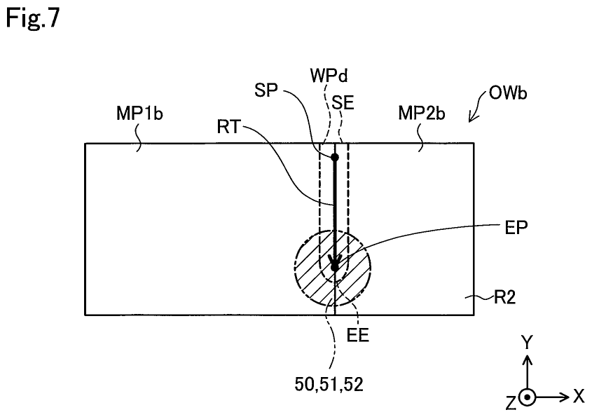

FIG. 7 is a view for describing the target portion WPd according to the third embodiment. The target portion WPd according to the present embodiment extends between the first plate member MP1b and the second plate member MP2b along the Y direction. That is, in the present embodiment, the welding laser irradiation unit 20 welds between the first plate member MP1b and the second plate member MP2b. More specifically, in the present embodiment, the control unit 90 moves the irradiation position IP in the Y direction at the time of welding.

Similar to FIG. 2, in FIG. 7, a hatching that goes in the upper right direction is applied to an area in which the heating device 50 is disposed when seen from the Z direction. Similar to the first embodiment, in the present embodiment, too, the heating device 50 heats the end edge part EE of the target portion WPd, so that it is possible to effectively prevent cracking at the end edge part EE.

The laser welding device 10 according to the above-described fourth embodiment can prevent the configuration of the heating device 50 from being restricted due to the welding laser irradiation unit 20.

Furthermore, the welding method according to the fourth embodiment may be penetration welding or may be non-penetration welding. Furthermore, the laser welding device 10 according to the fourth embodiment may be provided with, for example, the cover member 60 similar to the second embodiment. Furthermore, similar to, for example, welding described in the third embodiment, the laser welding device 10 according to the fourth embodiment may weld the object OWb while moving the irradiation position IP drawing the circumferential shape.

### E. Fifth Embodiment

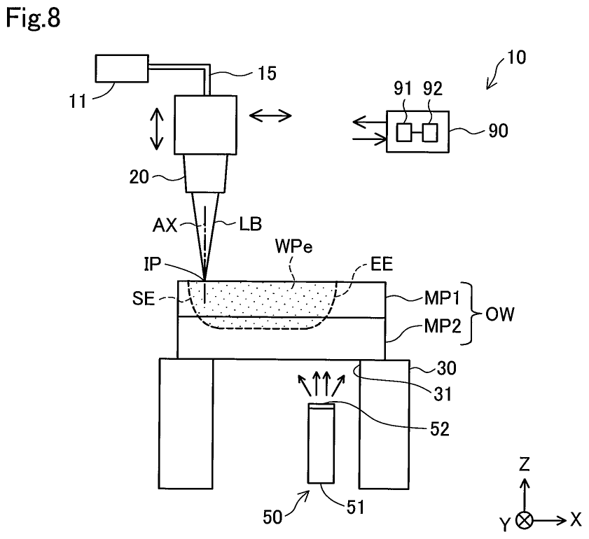

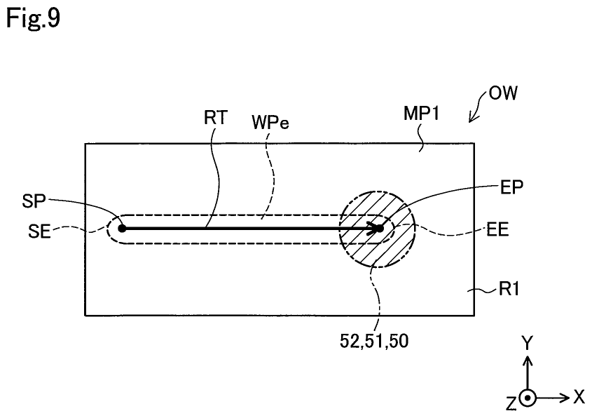

FIG. 8 is a first view for describing a target portion WPe according to the fifth embodiment. FIG. 9 is a second view for describing the target portion WPe according to the fifth embodiment. Note that, similar to FIG. 1, in FIG. 8, a hatching of a dot pattern is applied to the target portion WPe. In the present embodiment, the target portion WPe does not extend to an edge on the −X direction side of the object OW unlike the first embodiment. Hence, the start edge part SE is located at a position in the +X direction compared to the edge in the −X direction of the object OW. Parts that are not described in particular in the configuration of the laser welding device 10 according to the fifth embodiment are the same as those of the first embodiment. Even this configuration can prevent the configuration of the heating device 50 from being restricted due to the welding laser irradiation unit 20. Note that, in a case where, for example, the object OW is subjected to penetration welding similar to the third embodiment, the start edge part SE may not be located at the edge of the object OW. Furthermore, similar to the fourth embodiment, even in the case where the first plate member MP1 and the second plate member MP2 are aligned in the planar direction, the start edge part SE may not be located at the edge of the object OW.

### F. Other Embodiment

(F1) The object OW includes the two members in the above embodiments, but the object OW may include three or more members. Furthermore, each member that constitutes the object OW may not have a plate shape, and may have, for example, a bar shape. Furthermore, the object OW may not have the plate shape as a whole, and may have, for example, a bar shape. Furthermore, the object OW may not be made of aluminum, and may be formed using, for example, other metals such as iron or magnesium or various alloys, or may be formed using ceramics. Furthermore, for example, materials of the members that constitute the object OW may be different from each other.
(F2) In the above embodiments, the heating device 50 is disposed such that the heating device 50 overlaps at least part of the end edge part EE when seen from the Z direction. In contrast, the heating device 50 may not be disposed overlapping the end edge part EE when seen in the Z direction. In this case, the heating device 50 may heat the end edge part EE in a state where the heating device 50 is disposed without overlapping the end edge part EE. Furthermore, the heating device 50 may not heat the end edge part EE. That is, the heating device 50 may heat only a portion of the target portion WP different from the end edge part EE.
(F3) In the above embodiments, the irradiation position IP may be moved by, for example, moving the object OW with respect to the welding laser irradiation unit 20. In this case, for example, an electric actuator that moves the stage 30 may be provided, and this electric actuator may be controlled by the control unit 90 to move the object OW placed on the stage 30 with respect to the welding laser irradiation unit 20. In this case, the heating device 50 may be configured to, for example, move with respect to the welding laser irradiation unit 20 together with the stage 30.
(F4) In the above embodiments, the movement route RT of the irradiation position IP has the linear shape or the circumferential shape. In contrast, the movement route RT may not have the linear shape or the circumferential shape, and may be, for example, a route having a shape formed by combining a plurality of straight lines, or a route having a shape formed by combining a plurality of curves, or a route having a shape formed by combining straight lines and curves.
(F5) In the above embodiments, the welding laser irradiation unit 20 is configured to weld the object OW while moving the irradiation position IP of the laser light LB. In contrast, the welding laser irradiation unit 20 may weld the object OW while fixing the irradiation position IP.
(F6) In the above embodiments, the heating device 50 may be configured as the lamp 51. In contrast, the heating device 50 may not be configured as the lamp 51, and may be configured as an arbitrary non-contact type or contact-type heating device. For example, the heating device 50 may be configured as a sheathed heater, a blower that blows warm air to the object OW, an induction heating device that heats the object OW by induction heating, or a laser irradiation unit that radiates laser light for preheating the object OW.

The present disclosure is not limited to the above-described embodiments, and can be implemented by various configurations without departing from the gist of the present disclosure. For example, the technical features in the embodiments and their modifications can be replaced or combined as appropriate to solve part or entirety of the above-described problem, or to achieve part or entirety of the above-described effect. Furthermore, unless these technical features are described as indispensable in this description, the technical features can be deleted as appropriate. For example, the present disclosure may be achieved by aspects described below.
(1) One aspect of the present disclosure provides a laser welding device that welds an object to be welded including two or more members. This laser welding device includes a welding laser irradiation unit that faces the object, the welding laser irradiation unit welding the object by irradiating a target portion of the object with laser light; and a heating device disposed on an opposite side to the welding laser irradiation unit seen from the object, the heating device preheating the target portion by heating the target portion from the opposite side.

According to this aspect, the heating device is disposed on the opposite side to the welding laser irradiation unit seen from the object, and this heating device heats the target portion from the opposite side to the welding laser irradiation unit, so that it is possible to preheat the target portion. Consequently, it is possible to prevent the configuration of the heating device from being restricted by the welding laser irradiation unit compared to a case where the heating device is disposed on the same side as that of the welding laser irradiation unit.
(2) According to the above aspect, the object may include a first plate member and a second plate member as the members, and the first plate member and the second plate member may be mutually laminated.
(3) According to the above aspect, the object may include a first plate member and a second plate member as the members, the first plate member and the second plate member may be aligned in a planar direction, and the welding laser irradiation unit may weld between the first plate member and the second plate member.
(4) According to the above aspect, the welding laser irradiation unit may be configured to weld the object while moving an irradiation position of the laser light on the object along a predetermined movement route, the target portion may include a start edge part that is welded at a start point of the movement route, and an end edge part that is welded at an end point of the movement route, and the heating device preheats the end edge part by heating the end edge part. According to this aspect, the heating device can preheat the end edge part, so that it is possible to effectively prevent cracking of the object.
(5) According to the above aspect, the object may have a plate shape, the welding laser irradiation unit may irradiate a plate surface of the object with the laser light, and the heating device may be disposed overlapping at least part of the end edge part when seen from a plate thickness direction of the object. According to this aspect, it is possible to preheat the end edge part in a state where the heating device is disposed closer to the end edge part compared to an aspect where, for example, the heating device does not overlap the end edge part when seen from the plate thickness direction. Consequently, the heating device can more effectively preheat the end edge part, and it is possible to more effectively prevent cracking of the object.
(6) According to the above aspect, the heating device may be configured as a lamp that heats the target portion by irradiating the object with infrared light, an irradiation unit of the lamp may be disposed facing the object, the laser welding device may further include a cover member that is disposed between the object and the irradiation unit, and covers part of the irradiation unit, and the cover member may have higher heat resistance than heat resistances of the object and the irradiation unit. According to this aspect, the cover member can protect the irradiation unit of the lamp from the laser light. Furthermore, it is possible to effectively heat the target portion by infrared light radiated from the irradiation unit compared to an aspect where the entire irradiation unit is covered with the cover member.

The present disclosure can be implemented as various aspects such as a laser welding method and a control method for the laser welding device in addition to the aspect of the above-described laser welding device.

What is claimed is:

1. A laser welding device that welds an object to be welded including two or more members comprising:
a welding laser irradiation unit that faces the object, the welding laser irradiation unit welding the object by irradiating a target portion of the object with laser light; and
a heating device disposed on an opposite side to the welding laser irradiation unit seen from the object, the heating device preheating the target portion by heating the target portion from the opposite side.

2. The laser welding device according to claim 1, wherein
the object includes a first plate member and a second plate member as the members, and
the first plate member and the second plate member are mutually laminated.

3. The laser welding device according to claim 1, wherein
the object includes a first plate member and a second plate member as the members,
the first plate member and the second plate member are aligned in a planar direction, and
the welding laser irradiation unit welds between the first plate member and the second plate member.

4. The laser welding device according to claim 1, wherein
the welding laser irradiation unit is configured to weld the object while moving an irradiation position of the laser light on the object along a predetermined movement route,
the target portion includes a start edge part that is welded at a start point of the movement route, and an end edge part that is welded at an end point of the movement route, and
the heating device preheats the end edge part by heating the end edge part.

5. The laser welding device according to claim 4, wherein
the object has a plate shape,
the welding laser irradiation unit irradiates a plate surface of the object with the laser light, and
the heating device is disposed overlapping at least part of the end edge part when seen from a plate thickness direction of the object.

6. The laser welding device according to claim 1, wherein
the heating device is configured as a lamp that heats the target portion by irradiating the object with infrared light,
an irradiation unit of the lamp is disposed facing the object,
the laser welding device further comprises a cover member that is disposed between the object and the irradiation unit, and covers part of the irradiation unit, and
the cover member has higher heat resistance than heat resistances of the object and the irradiation unit.
